(19) United States
(12) Patent Application Publication
(10) Pub. No.: US 2019/0060144 A1
(43) Pub. Date: Feb. 28, 2019

(54) Mid-wheel tilt-in-space manual wheelchair with constant shoulder position

(71) Applicant: LES EQUIPEMENTS ADAPTES PHYSIPRO, INC., Sherbrooke, Quebec (CA)

(72) Inventors: Alexandre St-Cyr, Sherbrooke, Quebec (CA); Jean-Luc Lessard, Sherbrooke, Quebec (CA)

(21) Appl. No.: 16/079,885

(22) PCT Filed: Feb. 24, 2017
(86) PCT No.: PCT/CA2017/050243

§ 371 Date: Aug. 24, 2018

Related U.S. Application Data
(60) Provisional application No. 62/299,056, filed on Feb. 24, 2016.

(51) Int. Cl. A61G 5/10; A61G 5/12; A61G 5/06

(52) U.S. Cl. CPC A61G 5/1075; A61G 5/125; A61G 5/10; A61G 5/02; A61G 5/1059; A61G 5/107; A61G 5/1054; A61G 5/061

(57) ABSTRACT

The present discloses a mid-wheel tilt-in-space manual wheelchair with a constant shoulder position. The tilting wheelchair comprises an upper section, a lower section and a tilting mechanism. The upper section comprises an upper frame defining a user's seat, a back post and an armrest. The lower section comprises a lower frame, two drive wheels and at least two guiding wheels, preferably, two rear casters and two front casters. The two drive wheels being positioned on the lower frame and have a same rotation axis. The tilting mechanism is being adapted to rotatably engage the upper section to the lower section in such a way that the pivot center of the upper section is being coincident at any moment and any position with the rotation axis of the drive wheels allowing to maintain a constant distance between a user's shoulder and each pushrim of each drive wheel.

### CROSS-REFERENCE TO RELATED APPLICATIONS

The present patent application claims the benefits of priority of U.S. Provisional Patent Application No. 62/299,056, entitled “Mid-wheel tilt-in-space manual wheelchair with constant shoulder position” and filed at the United States Patent and Trademark Office on Feb. 24, 2016.

### FIELD OF THE INVENTION

The present invention generally relates to manual and tilt-in space wheelchairs. More particularly, the present device relates to a mid-wheel tilt in-space manual wheelchair with constant shoulder position.

### BACKGROUND OF THE INVENTION

Generally, wheelchairs are used by people to compensate for some disabilities and to fulfill specific disability needs. Sometimes, one may require using a tilt-in space wheelchair. Tilt-in space wheelchairs are intended to change the orientation of the user of a wheelchair in order to properly redistribute the pressure or load on the user's body. The tilt-in-space wheelchairs are typically categorized by the position of their pivot center and by the mechanism for tilting. Thus, such two properties condition the ease of manufacturing, the stability and the tilting possible range of wheelchairs.

Conventionally, tilt-in space wheelchairs, such the wheelchair disclosed in U.S. Pat. No. 6,409,265, typically comprise smaller rear wheels and do not allow the user to manually propel the wheelchair. For self-propulsion, larger wheels each having a push rim are generally required. For stability purpose, such wheels need to be rearward, especially due to the center of mass shift during the tilting of the wheelchair. However, such a configuration may render wheelchairs improper for self-propulsion.

Lately, tilt-in space wheelchairs with a mid-wheel configuration have been introduced. The propulsion wheels are then position between two set of caster wheels to maintain stability. The propulsion wheels are then easier to reach by the patient. However, the tilting pattern generally is non-optimal for self-propulsion wheelchairs. Such tilting wheelchairs present a risk of mechanical interference between the armrests and the propulsion wheels of the wheelchair. Such interference typically occurs during the tilting of the user's seat. Thus, such a mechanical interference presents many physical dangers to the user itself and may present a dysfunctional design of the wheelchair.

Furthermore, during the tilting of conventional wheelchairs, the user may sometimes lose the accessibility to drive the propulsion wheels since that the distance between the user's shoulder and the drive wheels is not constant.

Finally, to avoid the loss of accessibility to the drive wheels by a user and to avoid any possible mechanical interference, the tilting angle of conventional wheelchairs is generally limited.

Thus, there is a need for an improved wheelchair aiming at mitigating the shortcomings of the prior art by allowing tilting of the user of a wheelchair while allowing the drive wheels to be used.

### SUMMARY OF THE INVENTION

The aforesaid and other objectives of the present invention are realized by generally providing a tilting wheelchair allowing a user to keep a constant distance from the drive wheels whether in a straight position or a tilted position.

The present invention allows avoiding any possible mechanical interference between the armrests of a wheelchair and the drive wheels during the tilting of the user's seat.

In one aspect of the invention, a tilting wheelchair is provided. The tilting wheelchair comprises an upper section adapted to receive a user, a lower section and a pair of drive wheels pivotally mounted to the lower section on each side of the wheelchair; the drive wheels being pivotally mounted about a first rotation axis. The tilting wheelchair further comprises a first guiding wheel pivotally mounted to the lower section and a tilting mechanism being adapted to pivotally connect the upper section and the lower section about a second rotation axis. The first rotation axis is always coincident with the second pivoting axis independently of position of the upper section in relation to the lower section.

The tilting wheelchair may further comprise a second guiding wheel in such a way that the pair of drive wheels is being longitudinally mounted between the first and second guiding wheels.

In another aspect of the invention, the tilting wheelchair may further comprise a pair of first guiding wheels and a pair of second guiding wheels, each pair is being mounted on each side of the wheelchair.

In yet another aspect of the invention, the upper section comprises an upper frame comprising a seat, a back post and at least one armrest while the lower section comprises a lower frame to which the drive wheels and the guiding wheels are being mounted.

In a further aspect of the invention, the tilting mechanism rotatably engages the lower frame and the drive wheel rigidly engages the lower frame. The tilting mechanism is having a pivot center being coincident at any moment and any position with the rotation axis of the drive wheels.

In another aspect of the invention, a first side of the lower frame is being adapted to engage the drive wheel and a second side of the lower frame is being adapted to engage the tilting mechanism.

In yet another aspect of the invention, the tilting mechanism may comprise a seat bracket attached to the upper section. The tilting mechanism may further comprise a pivot bracket being adapted to rotate in relation to the lower section and the seat bracket is being attached to the pivot bracket. The seat bracket may be pivotally connected to the lower section.

In a further aspect of the invention, the seat bracket comprises a first opening, the lower section comprises a second opening and the drive wheel comprises an axel adapted to be locked into the first and second opening.

In another aspect of the invention, the tilting mechanism further comprises a cylinder adapted to engage and rotate the seat bracket. The tilting mechanism may further comprise a locking mechanism wirely controlled by a release handle; the locking mechanism being adapted to activate retracting or stretching of the cylinder; the retracting or stretching of the cylinder drives the tilting of the upper section.

In yet another aspect of the invention, the tilting mechanism may further comprise a force compensating system allowing easier tilting. The force compensating system may comprise a cylinder having a low nominal force and a compression spring.

In a further aspect of the invention, the rear guiding wheel is adapted to climb stairs. The tilting wheelchair is further adapted to allow vertical and horizontal adjustments of the position of the seated user.

The present invention also provides a method for tilting a seat bracket of a wheelchair comprising drive wheels mounted about a rotation axis. The seat bracket is being pivoting about the rotation axis, the method comprises a step of releasing a locking mechanism of a tilting mechanism connected to a seat bracket; a step of pivoting the seat bracket about the rotation axis and a step of locking the tilting mechanism to retain the seat bracket in place.

In another aspect of the invention, the method may further comprise a step of unlocking a cylinder attached to the seat bracket to allow tilting of the seat bracket and a step of locking the cylinder to maintain the position of the seat bracket.

In another aspect of the invention, the method may further comprise a step of activating a handle to trigger unlocking of the cylinder and a step of activating a handle to trigger locking of the cylinder.

The features of the present invention which are believed to be novel are set forth with particularity in the appended claims.

### BRIEF DESCRIPTION OF THE DRAWINGS

The above and other objects, features and advantages of the invention will become more readily apparent from the following description, reference being made to the accompanying drawings in which:

FIG. 1 is a side view (sagittal plane for user) of a wheelchair in accordance with the principles of the present invention, the wheelchair being shown in a mid-wheel configuration having the seat in both, straight and tilted position.

FIG. 2 is a side view (sagittal plane for user) of the wheelchair of FIG. 1 showing the distance of the shoulder of a user in relation to the mid-wheel.

FIG. 3 is a side view of the lower frame of the wheelchair of FIG. 1, showing a possible vertical adjustment of the wheelchair's seat position.

FIG. 4 is a side view of the wheelchair of FIG. 1, the wheelchair being shown in different horizontal adjustment configurations.

FIG. 5 is a side view of a wheelchair in accordance with the principles of the present invention, the FIG. 5 showing the center of mass of a user being in a straight position.

FIG. 6 is a side view of the wheelchair of FIG. 5 showing the center of mass of a user in a tilted position.

FIG. 7 is a sectional view of the assembly of the tilting mechanism of the wheelchair of FIG. 1.

FIG. 8 is an exploded view of an tilting mechanism of the wheelchair of FIG. 1.

FIG. 9 is a side view of the wheelchair of FIG. 1 showing the tilting mechanism and a tilting blocking mechanism.

FIG. 10 is a close-up view of the tilting mechanism of the wheelchair of FIG. 9.

FIG. 11 is a schematic view of the position of the center of mass of a user of the wheelchair user being in a straight position

FIG. 12 is a schematic view of the position of the center of mass of a user of a wheelchair being in a tilted position.

FIG. 13 is a side view of the center of mass of the wheelchair of FIG. 1, the wheelchair being shown without the mid-wheels.

FIG. 14 is a side view of the center of mass of the wheelchair of FIG. 13 shown in a tilted position.

FIG. 15 is a side view of a second embodiment of a wheelchair in accordance with the principles of the present invention having tilting and a tilting blocking mechanisms.

FIG. 16 is a close-up side view of the tilting mechanism of the wheelchair of FIG. 15.

FIG. 17 is a front view of a wheelchair in accordance with the principles of the present invention with a mid-wheel configuration.

FIG. 18 is a bottom view of the wheelchair of FIG. 17.

### DETAILED DESCRIPTION OF THE PREFERRED EMBODIMENT

A novel mid-wheel tilt in space manual wheelchair with constant shoulder position will be described hereinafter. Although the invention is described in terms of specific illustrative embodiments, it is to be understood that the embodiments described herein are by way of example only and that the scope of the invention is not intended to be limited thereby.

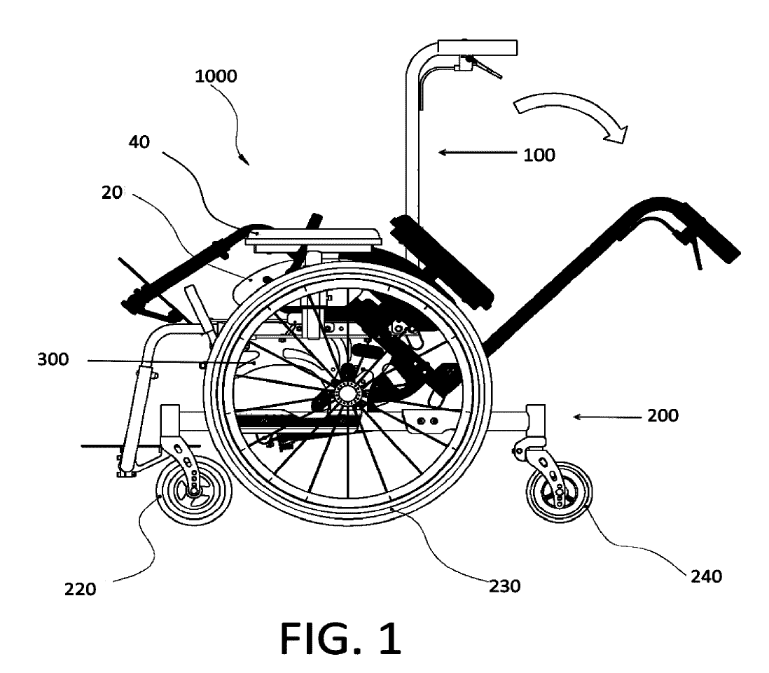

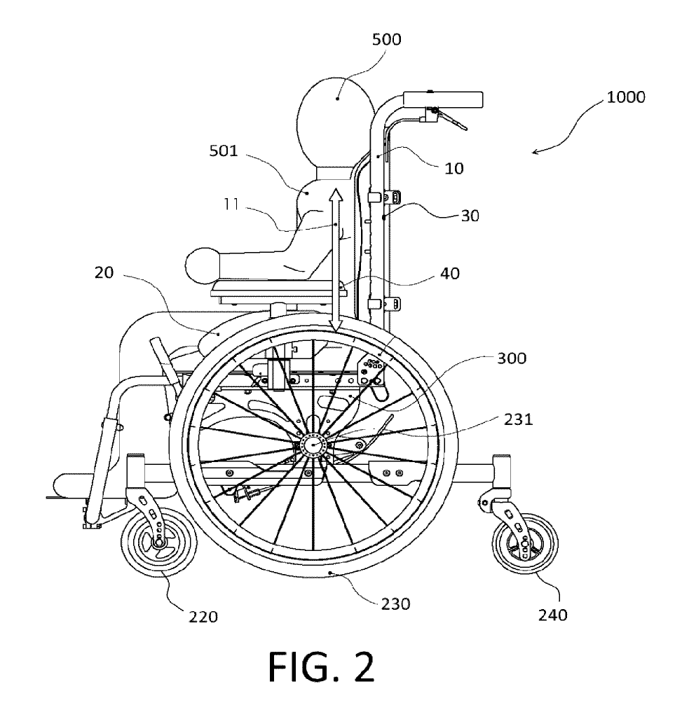

Referring to FIGS. 1 and 2, a preferred embodiment of a tilt in space wheelchair 1000 is illustrated. The manual wheelchair 1000 generally comprises an upper section 100 pivotally connected to a lower section 200. Typically, the upper section 100 is pivotally connected using seat brackets 300. In a typical embodiment, the upper section 100 comprises an upper portion or frame 10 generally defining a seat 20 for a user and may further comprise a back post 30 forming an angle of about 90 degrees in relation with the seat 20. In a preferred embodiment, the upper section 100 may further comprise an armrest 40 on each side of the wheelchair 1000.

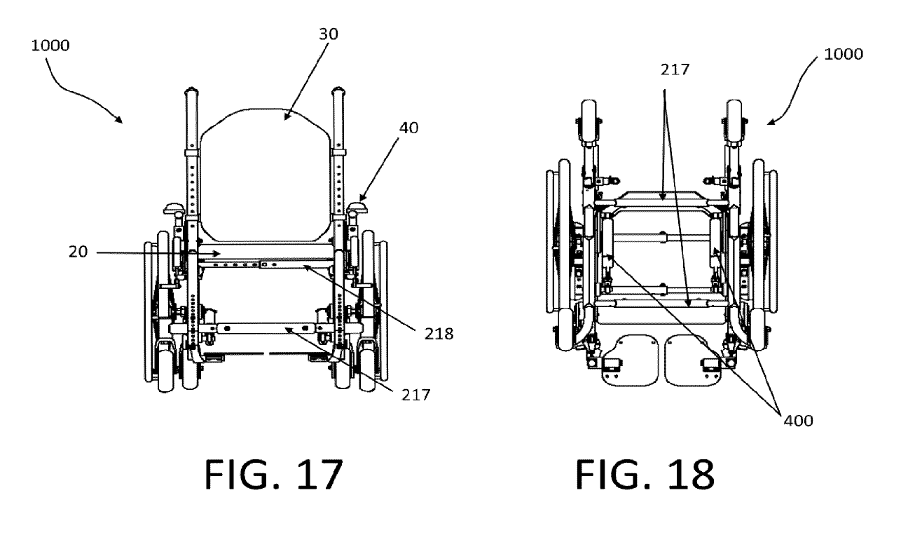

Understandably, in a preferred embodiment, as shown in FIGS. 17 and 18, the wheelchair is generally configured to be symmetrical with regard to a longitudinal plan. Still referring to FIGS. 17 and 18, both sides of the upper frame 10 are being generally connected by means of at least two rods 218 while both sides of the lower frame 200 are connected together by means of at least two rods 217 and each side of the wheelchair 1000 comprises a tilting mechanism. It shall be understood by one skilled in the art that any other mean of connecting each side of the wheelchair 1000 may be used in order to provide a structure supporting the weight of the user being seated.

Thus, due to the symmetrical aspect of the preferred embodiment, only one side of the wheelchair will be described herein below.

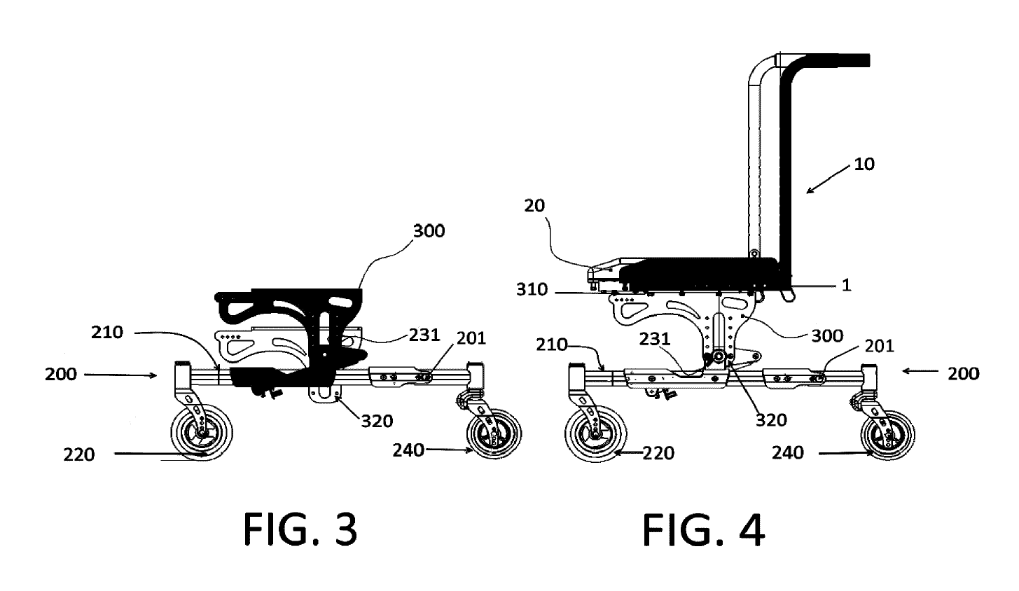

Now referring to FIGS. 3 and 4, the stripped down version of the wheelchair 1000 is shown with the adjustable seat brackets 300 being shown in different vertical positions (FIG. 3) and the upper portion 10 being shown in different longitudinal positions (FIG. 4). The bottom section 1 of the upper portion 10 is attached to the top portion 310 of the seat brackets 300. The bottom section 320 of the seat brackets 300 is pivotally connected to the lower section 200 with tilting means or mechanism 400 (see, for instance, FIG. 10). The lower section 200 may comprise a lower frame 210 adapted to receive, on each side, a front wheel 220, a mid-wheel 230, having a rotation axis 231, and a rear wheel 240. Typically, the front wheel 220 and/or rear wheel 240 shall be embodied as caster wheels to ensure better manoeuvrability of the wheelchair 1000.

Understandably, as shown in FIGS. 1 to 4, the wheelchair 1000 in a mid-wheel configuration generally comprises two drive wheels 230. Each drive wheel 230 is pivotally mounted to each side of the wheelchair 1000 about the rotation axis 231. Each drive wheel 230 is longitudinally mounted to the wheelchair 1000 between a front caster 220 and a rear caster 240.

In a preferred embodiment, the two drive wheels 230 are mounted about the same rotation axis 231. In the said preferred embodiment, two front wheels 220, two drive wheels 230 and two rear wheels 240 are mounted to the wheelchair 1000, aiming at improved stability for a seated user 500, either in straight or tilted position. The 6-wheels configuration also aims at improving the use of the wheelchair 1000 on different surfaces.

In a preferred embodiment, the seat bracket 300 is adapted to provide vertical and horizontal adjustments of the seat. In some embodiment, the rear wheel 240 are pivotally mounted to the lower frame 210 about a lateral axis 201. Such pivoting of the wheels 240 aims at improving the wheelchair 1000 to travel on inclined surfaces and the wheelchair 1000 to climb stairs up and down.

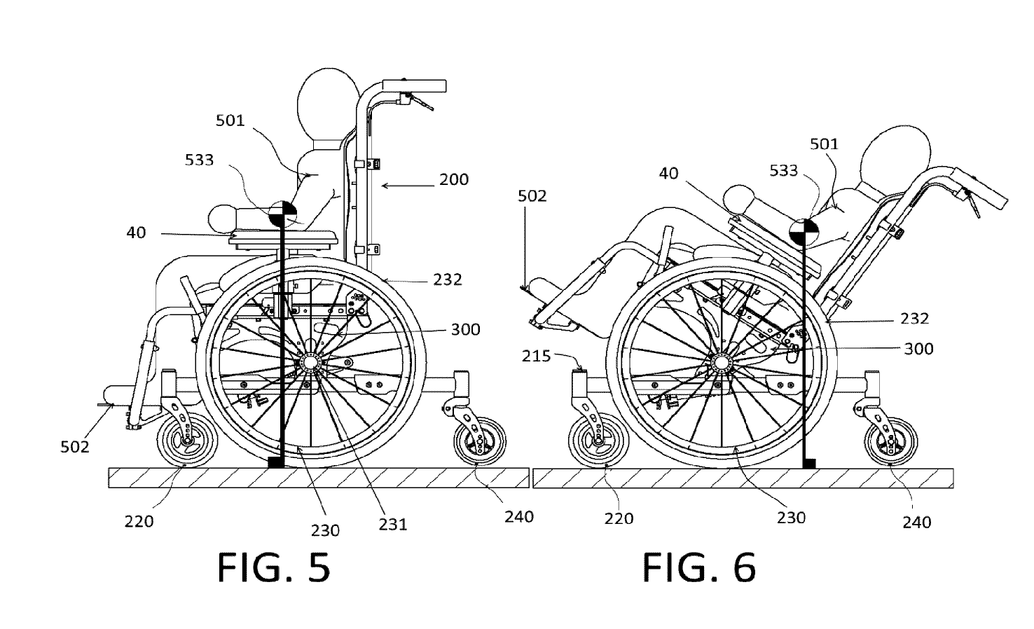

Referring now to FIGS. 5 and 6, the center of mass 533 of an embodiment of the wheelchair 1000 is shown when a user is in straight position and in tilted position. In such an embodiment, the seat bracket 300 supporting the upper section 200 rotates around the pivot axis 231 of the mid wheel 230 by the mean of the tilting mechanism 400 (see FIG. 10). In such an embodiment, the pivot point of the upper section 200 is always coincident with the pivot axis 231 of the mid wheel 230. As the pivot point of the upper section 200 is coincident with the pivot axis 231 of the mid wheel 230, the distance between a member of the user, typically the shoulder 501 or the elbow, and the periphery of the mid-wheel 230 or, in some embodiments, the periphery of a push rim 232, is always the same, independently of the tilting position of the upper section or seat, such as straight position or in tilted position.

Still referring to FIG. 5, in the straight position, the optional armrests 40 are initially positioned to accommodate the position of the user. The instant coincidence of the pivot point of the upper section 200 and the rotation axis 231 of the mid wheel 230 limits or eliminates mechanical interference between the armrests 40 and the drive wheels 230 during operations of the wheelchair 1000, such as when tilting of the upper section 200 or when using the drive wheels 230.

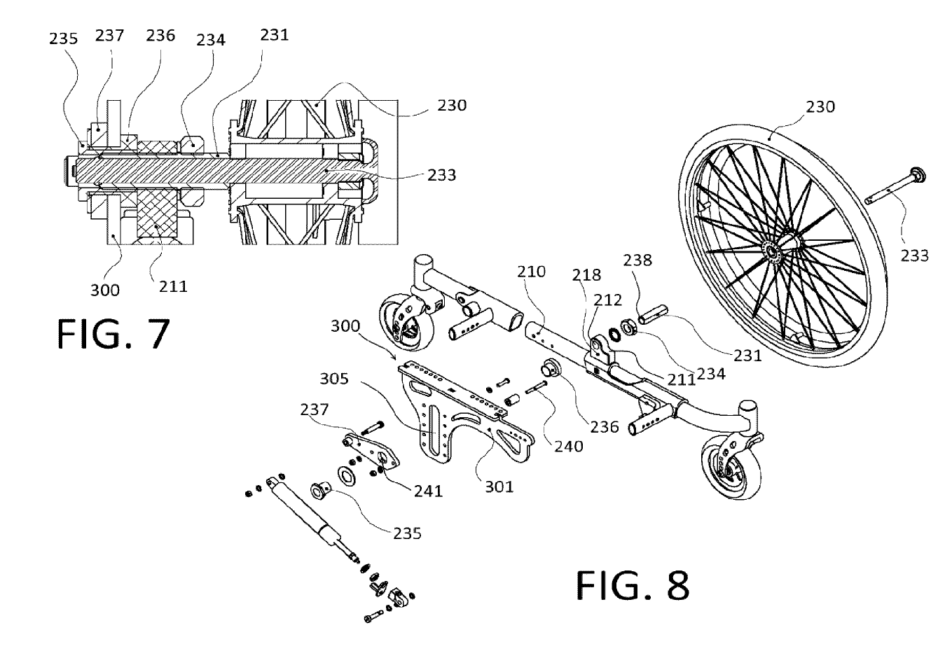

Referring now to FIG. 7, a sectional view of the tilting mechanism of an embodiment of the wheelchair 1000 is shown.

Referring now to FIG. 8, an exploded view of the tilting mechanism and the mounting of a mid-wheel 230 is shown. In such an embodiment, the lower frame 210 comprises, on each side, a wheel support structure 211 being adapted to mount the mid-wheels along a mediolateral direction and to pivotally connect the seat bracket 300 and the support structures 211. The support structures 211 are preferably welded to the lower frame 210 or to an intermediate structure being attached to the lower frame 210. Understandably, any other means known in the art to attach the support structures 211 to the lower frame 210 may be used without departing from the principles of the present invention.

Still referring to FIG. 8, each support structure 211 comprises a opening 212, such as a threaded opening, adapted to receive a rotation axel or pin 231 of the mid-wheel 230. In some embodiments, the rotation axel may be threaded. The rotation axle 231 is mounted in the opening 212. In a preferred embodiment, a quick release pin 233 is inserted through the opening 212 and through an opening 305 of the seat bracket 300. By pivotally mounting the mid-wheel 230 to the support structure 211 using the pin 233, the support structure 211 is also pivotally connected to the seat bracket 300. The pin 233 is locked upon insertion using a locking means 235.

In a preferred embodiment, the means for mounting the wheel 230 further comprises a axel 231, preferably a threaded axle, adapted to be inserted in the opening 212 and in the opening 305 of the seat bracket 300. The axel 231 may be adapted to be locked in place using a nut 234 and may further comprise a bushing 231 between the seat bracket aperture 305 and the opening 212.

From the other side 301 of the opening 305 of the seat bracket 300, a pivot bracket 237 may be secured to the seat bracket 300 by a fastener means, such as but not limited to, pivot bolt 240. The pivot bracket 237 is being secured to the side 301 of the bracket seat 300 in a way to have the opening 305 of the bracket seat 300 perfectly aligned and centred with an opening 241 of the pivot bracket 237.

Still referring to FIGS. 7 and 8, in a preferred embodiment, a shoulder sleeve 235 is adapted to be inserted through the opening 241 of the pivot bracket 237 in a way to abut on a side of the pivot bracket, in away to pass through the opening 305 of the bracket seat 300 and in away to engage the bushing 236 which is adapted to be freely rotating around the sleeve 235 while being captive in the mediolateral direction. As a result, the pivot bracket 237 is secured to the bracket seat 300, is adapted to freely rotate around the mid-wheel axel 231.

Understandably, any other means know in the art to pivotally mount the mid-wheel 230 to the frame 200 using a pivoting axis being coincident with the pivoting axis of connecting between the seat bracket 300 and the frame 200 may be used without departing from the present invention.

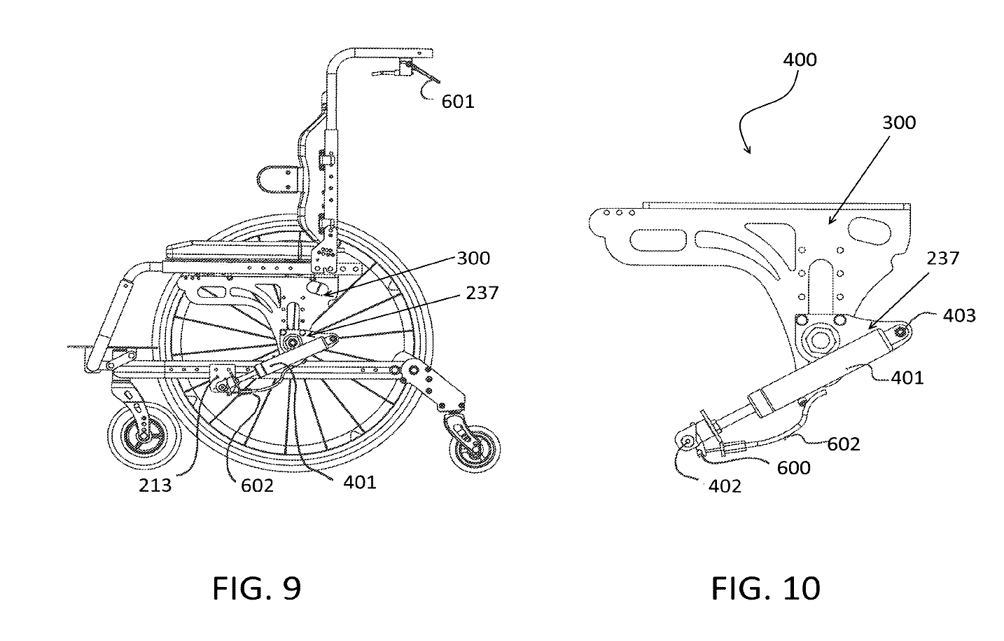

Referring now to FIGS. 9 and 10, a preferred embodiment of a tilting mechanism 400 is illustrated. The tilting mechanism 400 comprises a pivot bracket 237 attached to the seat bracket 300 and a pivot control means 401, such as linear cylinder or actuator, preferably a gas cylinder. As discussed above, the pivot bracket 237 is adapted to pivot about the lower frame 200 of the wheelchair 1000. The pivot control means 401 is adapted to rotate and block the tilting of the seat to a desired position. In embodiment having a linear cylinder 401, the cylinder 401 comprises a mobile end 403 and a fixed end 402. The fixed end 402 of the linear cylinder 401 is typically attached to the lower frame 210 by mean of an attach support 213. The mobile end 403 of the linear cylinder 401 is attached to the pivot bracket 237.

In yet another embodiment, the gas cylinder 401 may comprise a locking mechanism 600 being controlled by a release handle 601. The locking mechanism 600 is connected to the release handle 601 by mean of a guided wire 602. Thus, once an attendant activates the release handle 601, the guided wire 602 is being pulled and the locking mechanism is then released. The linear cylinder 401 is then adapted to be retracted or stretched. The retraction or stretching of the linear cylinder 401 activates the rotation of the pivot bracket 237 being rigidly attached to the seat bracket 300. Thus, the rotation of the seat bracket drives the tilting of the user's seat of the wheelchair.

Understandably, in other means of controlling the tilting of the seat bracket 300 may be used, such as a means allowing predetermined tilting positions. Such means could include locking the seat bracket 300 in a predetermined position using a locking pin or locking buttons (not shown). In other embodiments, other locking mechanisms may be used such as a rotational locking mechanism or an incremental locking mechanism.

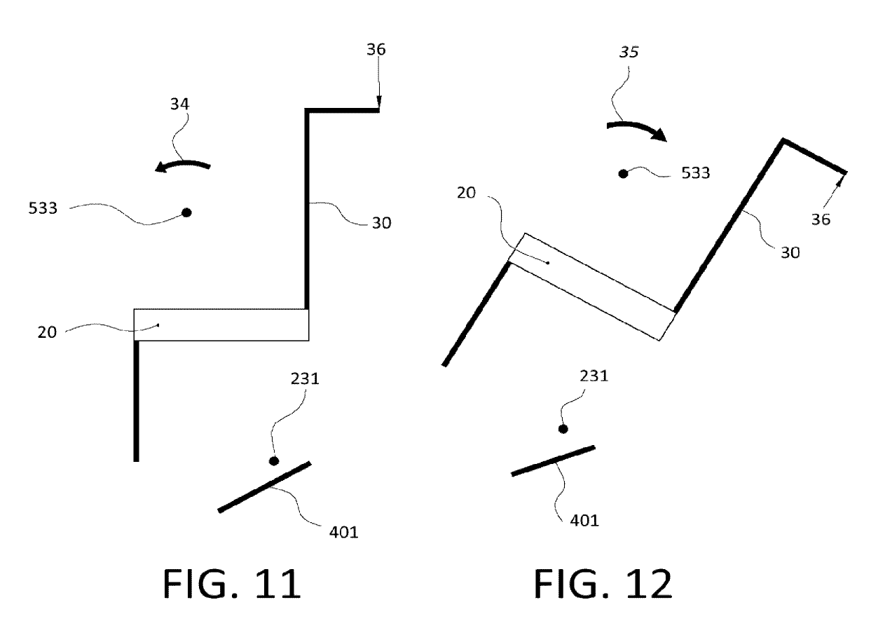

Referring now to FIGS. 11 and 12, two schematics views of the center of mass 533 of a wheelchair's user 500 are illustrated. FIGS. 11 and 12 shows that depending on the transition of the upper section between the straight and tilted position, the center of mass 533 of a user may move from the front to rear of the wheels axle 231 (pivoting axle). When the center of mass 533 is in front of the wheels axle 231, torque 34 tends to tilt the seat 20 of the user in the counter clockwise direction. When the center of mass 533 is at the rear of the wheels axle 231, torque 35 tends to tilt the user's seat 20 in the clockwise direction. In a embodiment having gas cylinder 401, the cylinder 401 applies force in one direction. Depending on the configuration, the user will have to apply a force 36 on the back post 30 to compensate the torque (34 or 35) creates by the movement of the center of mass 533 to which the gas cylinder force will be added at some point. For heavy user, the force 36 to apply may be out of the desirable limits.

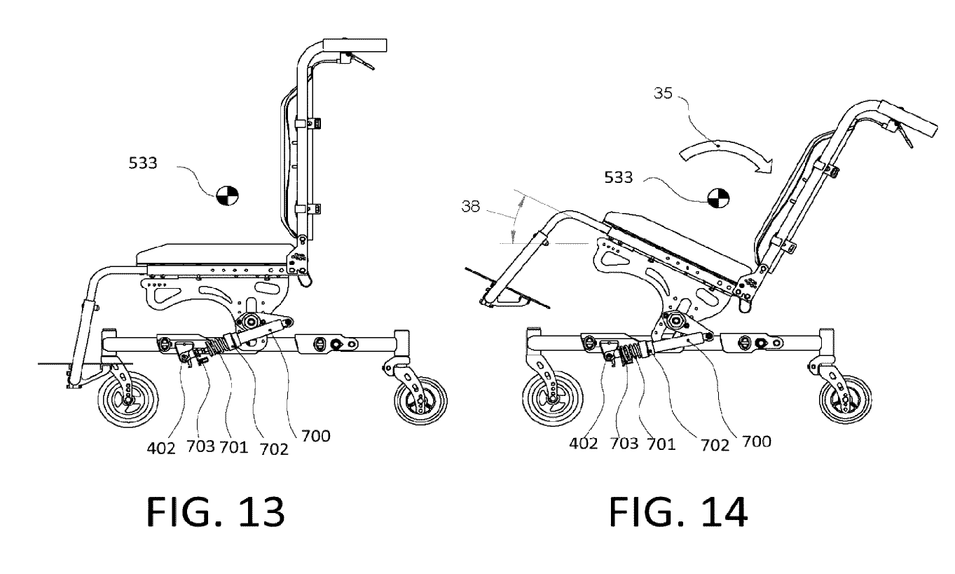

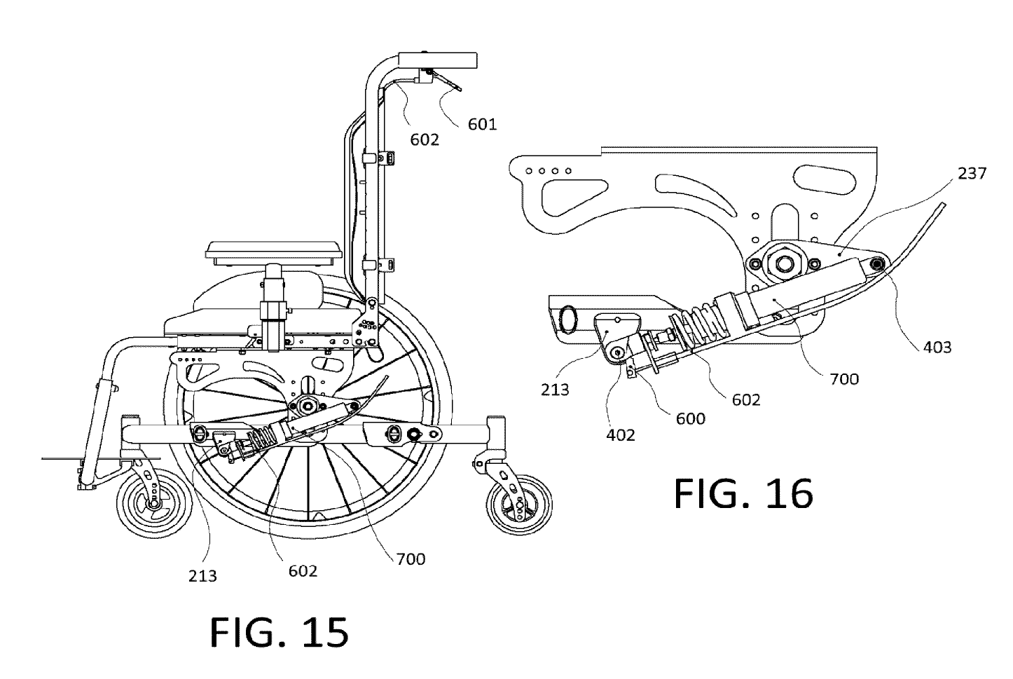

In another embodiment, as shown in FIGS. 13 to 16, the wheelchair tilting mechanism 400 may comprise a force compensating system that includes a gas cylinder 700 with very low nominal force and a compression spring 701 that will compensate only for the clockwise torque 35 created by the center of mass 533 of a user. When the seat angle 38 reaches a certain level, the compression spring 701 compresses between the thrust collar 702 installed on the gas cylinder 700 and the thrust bracket 703 on the fixed end of the gas cylinder 700. This system allows tilting a heavier user without exceeding the desirable force limit to be applied by the attendant.

Understandably, one skilled in the art must understand that a rotational configuration of a compensating force system may be used. Such a system may use torsion spring or elastomer spring element.

Referring back to FIGS. 5 and 6, a tilting mechanism comprising a force compensating system allows having the user center of mass 533 always between the foremost wheels, the front caster 220, and the rearmost wheels, the rear caster 240.

Understandably, the present invention may be applied for other wheelchair configuration but is primary intended for a mid-wheel configuration.

While illustrative and presently preferred embodiments of the invention have been described in detail hereinabove, it is to be understood that the inventive concepts may be otherwise variously embodied and employed and that the appended claims are intended to be construed to include such variations except insofar as limited by the prior art.

1) A tilting wheelchair comprising:
an upper section adapted to receive a user;
a lower section;
a pair of drive wheels pivotally mounted to the lower section on each side of the wheelchair, the drive wheels being pivotally mounted about a first rotation axis;
a first guiding wheel pivotally mounted to the lower section;
a tilting mechanism being adapted to pivotally connect the upper section and the lower section about a second rotation axis;
wherein the first rotation axis is always coincident with the second pivoting axis independently of position of the upper section in relation to the lower section.

2) The tilting wheelchair of claim 1, the tilting wheelchair further comprising a second guiding wheel, the pair of drive wheels being longitudinally mounted between the first and second guiding wheels.

3) The tilting wheelchair of any of claim 1 or 2, the tilting wheelchair further comprising a pair of first guiding wheels and a pair of second guiding wheels, each pair being mounted on each side of the wheelchair.

4) The tilting wheelchair of any of claims 1 to 3, wherein the upper section comprises an upper frame.

5) The tilting wheelchair of claim 4, the upper frame comprising a seat, a back post and at least one armrest.

6) The tilting wheelchair of claims 1 to 5, the lower section comprising a lower frame, the drive wheels and the guiding wheels being mounted to the lower frame.

7) The tilting wheelchair of claim 6, wherein the tilting mechanism rotatably engages the lower frame and the drive wheel rigidly engages the lower frame; the tilting mechanism having a pivot center being coincident at any moment and any position with the rotation axis of the drive wheels.

8) The tilting wheelchair of claim 6, a first side of the lower frame being adapted to engage the drive wheel and wherein a second side of the lower frame being adapted to engage the tilting mechanism.

9) The tilting wheelchair of any of claims 1 to 7, the tilting mechanism comprising a seat bracket attached to the upper section.

10) The tilting wheelchair of any of claims 1 to 9, the tilting mechanism further comprising a pivot bracket, the pivot bracket being adapted to rotate in relation to the lower section and the seat bracket being attached to the pivot bracket.

11) The tilting wheelchair of claim 9, the seat bracket being pivotally connected to the lower section.

12) The tilting wheelchair of claim 11, the seat bracket comprising a first opening and the lower section comprising a second opening, the drive wheel comprising an axel adapted to be locked into the first and second opening.

13) The tilting wheelchair of any of claim 11 or 12, the tilting mechanism further comprising a cylinder adapted to engage and rotate the seat bracket.

14) The tilting wheelchair of claim 13, the tilting mechanism further comprising a locking mechanism wirely controlled by a release handle; the locking mechanism being adapted to activate retracting or stretching of the cylinder; the retracting or stretching of the cylinder drives the tilting of the upper section.

15) The tilting wheelchair of claim 14, the tilting mechanism further comprising a force compensating system allowing easier tilting

16) The tilting wheelchair of claim 15, wherein the force compensating system comprises a cylinder having a low nominal force and a compression spring.

17) The tilting wheelchair of claim 2, wherein the rear guiding wheel being adapted to climb stairs.

18) The tilting wheelchair of any of claims 1 to 17, the tilting wheelchair being adapted to allow vertical and horizontal adjustments of the position of the seated user.

19) The tilting wheelchair of any of claims 1 to 18, the guiding wheels being caster.

20) A method for tilting a seat bracket of a wheelchair comprising drive wheels mounted about a rotation axis, the seat bracket being pivoting about the rotation axis, the method comprising:
releasing a locking mechanism of a tilting mechanism connected to a seat bracket;
pivoting the seat bracket about the rotation axis;
locking the tilting mechanism to retain the seat bracket in place.

21) The method for tilting a seat bracket of claim 20, the method further comprising:
unlocking a cylinder attached to the seat bracket to allow tilting of the seat bracket;
locking the cylinder to maintain the position of the seat bracket.

22) The method for tilting a seat bracket of claim 21, the method further comprising:
activating a handle to trigger unlocking of the cylinder;
activating a handle to trigger locking of the cylinder.
